(19) United States
(12) Patent Application Publication
(10) Pub. No.: US 2004/0208503 A1
(43) Pub. Date: Oct. 21, 2004

(54) Systems and methods for detecting faults in optical communication systems

(76) Inventor: William Shieh, Clarksville, MD (US)

Correspondence Address: HARRITY & SNYDER, LLP, 11240 WAPLES MILL ROAD, SUITE 300, FAIRFAX, VA, 22030, US

(21) Appl. No.: 10/003,247

(22) Filed: Dec. 6, 2001

(51) Int. Cl. H04B 10/08; H04B 10/02

(52) U.S. Cl. 398/13

(57) ABSTRACT

A method for locating faults in an optical communication system that includes at least two optical fibers begins by supplying an optical test signal to a first optical fiber. The optical test signal propagates on the first optical fiber in a first direction. A second optical fiber receives the optical test signal via a coupling device. The optical test signal propagates on the second optical fiber in the first direction, reaches a termination point and reflects back on the second optical fiber in a second direction opposite to the first direction. The reflected signal received on the second optical fiber may then be analyzed to determine whether a fault has occurred.

### BACKGROUND OF THE INVENTION

1. Field of the Invention

The present invention relates generally to optical communication systems and, more particularly, to systems and methods for detecting faults in optical communication systems.

2. Description of Related Art

Conventional optical communication systems are implemented using a number of pairs of optical fibers. For long haul optical communications, e.g., greater than several hundred kilometers, the optical signal is periodically amplified to compensate for attenuation of the signal. Repeaters are typically used to amplify the transmitted signal so that the signal arrives at its destination with adequate signal strength to be processed by devices at the destination. Conventional repeaters include optical amplifiers that amplify the optical signals and optical isolators that limit the propagation of the optical signal to a single direction.

Due to the lengths involved in long haul optical fiber transmission systems, methods for determining the location of faults that may occur along the transmission path are required. One conventional method for detecting faults uses an optical time domain reflectometer (OTDR) to analyze the light loss in an optical fiber. In typical systems using an OTDR, the OTDR injects a short, intense laser pulse into an optical fiber and measures the backscatter and reflection of light as a function of time. The reflected light characteristics are analyzed to determine the location of any fiber breaks or other discontinuities. A related technique, known as coherent optical time domain reflectometry (COTDR), is also used to detect faults in optical fibers. Readers interested in more information regarding OTDR and COTDR are referred to examples discussed in U.S. Pat. No. 5,511,086, the disclosure of which is incorporated here by reference. Hereafter, references to OTDR are intended to include both OTDR and COTDR.

As described above, conventional optical amplifiers include isolators. These isolators limit the optical signal propagation to a single direction, thereby eliminating backward propagating light and multipath interference. These isolators cause problems when trying to analyze the reflected light from OTDR pulses to determine whether a fault occurred. One conventional way to overcome this problem associated with the uni-directional behavior of isolators employs a coupler to optically couple the reflected light to a second optical fiber.

For example, FIG. 1 illustrates a conventional approach implemented in a repeater 100 for detecting faults in an optical communication system. The repeater 100 connects to optical fibers 110 and 120 and includes discrete amplifiers 130 and 140, isolators 150 and 160 and couplers 170 and 180. The discrete amplifiers 130 and 140 may, for example, be lengths of erbium doped fiber pumped by a laser source (not shown), i.e., erbium doped fiber amplifiers (EDFAs).

When a signal is transmitted on optical fiber 110, amplifier 130 amplifies the signal. The amplified signal then passes through isolator 150 and coupler 170 and reaches a termination point (e.g., a fault), labeled point 190 in FIG. 1. At termination point 190, the signal reflects back, as indicated by the dashed line. Isolator 150 prevents the reflected signal from returning over its original path on optical fiber 110. Instead, the reflected signal is optically coupled to optical fiber 120, via couplers 170 and 180, as indicated by the dashed lines. The return path for the reflected signal then continues on optical fiber 120 where it can be analyzed by the OTDR.

One problem with this configuration occurs when a filter is placed downstream of the coupler 170 in repeater 100. For example, it may be necessary or advantageous to place a filter outside the repeater 100 to compensate for signal variances such as gain excursion. In this case, the filter often includes an optical isolator that limits the light flow to one direction and prevents the backward propagation of light. Such an isolator effectively blocks the return path of the reflected light from reaching coupler 170, thereby preventing the reflected light from reaching the OTDR for analysis.

Another problem with this approach occurs in a distributed Raman amplified system as shown in FIG. 2. Distributed Raman amplification Distributed Raman amplification is one amplification scheme that can provide a broad and relatively flat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering radiation from a pump laser interacts with a gain medium through which the optical transmission signal passes to transfer power to that optical transmission signal. One of the benefits of Raman amplification is that the gain medium can be the optical fiber itself, i.e., doping of the gain material with a rare-earth element is not required as in EDFA techniques. The wavelength of the pump laser is selected such that the vibration energy generated by the pump laser beam's interaction with the gain medium is transferred to the transmitted optical signal in a particular wavelength range, which range establishes the gain profile of the pump laser. However, the typical gain profile of 20-30 nm for a single wavelength pump laser is too narrow to support the wide bandwidths of, e.g., 100 nm or more, that are desired for next generation optical communication systems. To broaden the gain profile, Raman amplifiers can use multiple pump lasers for generating pump laser wavelengths over a broad wavelength range. The individual gain profiles attributable to each pump laser sum to provide a combined gain profile that can be used to amplify a transmitted optical signal over a much wider bandwidth. Pump lasers can generate pump energy that is launched in a backwards (contrapropagating) direction relative to the optical data signal, a forward (copropagating) direction or both (bi-directional pumping).

FIG. 2 depicts a portion of an exemplary Raman amplified optical communication system employing a contrapropagating pumping scheme. Therein, repeater 200 includes pump lasers 204 which are coupled to optical fiber 206 via pump signal combiner 208. Pump light from pump lasers 204 propagates in the opposite direction of the optical data signal which is traveling over optical fiber 206 en route to repeater 200 and has the effect of providing distributed amplification to that signal over a relatively long span, e.g., 10-40 km. In a similar manner, the next repeater 210 in the chain will propagate its pump light toward repeater 200, a residual amount of which will reach repeater 200 and be coupled via couplers 212 and 214 into the power detector 216 along the path provided for OTDR reflections. This will have the unwanted effect that the power detector 216 will not provide accurate readings regarding the optical signal strength of the optical data signal propagating on optical fiber 218.

Accordingly, there is a need for systems and methods that provide for fault detection in optical fiber communication systems that may include optical isolators disposed outside the repeater along the communication paths.

### SUMMARY OF THE INVENTION

Systems and methods consistent with the present invention address this and other needs by configuring a coupling device upstream of an optical isolator on a first optical fiber. A test signal transmitted on the first optical fiber may then be directed to a second optical fiber. The test signal propagates on the second optical fiber, reaches a termination point and reflects back toward its origination point. The reflected test signal may then be analyzed.

In accordance with the principles of this invention as embodied and broadly described herein, a method of locating faults is provided in an optical communication system that includes at least two optical fibers. The method includes supplying an optical test signal to a first optical fiber. The optical test signal propagates on the first optical fiber in a first direction. The method also includes providing a coupling device to couple the first optical fiber to a second optical fiber and receiving the optical test signal on the second optical fiber via the coupling device. The optical test signal propagates on the second optical fiber in the first direction, reaches a termination point on the second optical fiber and reflects back on the second optical fiber in a second direction opposite to the first direction. The method further includes analyzing the reflected signal received on the second optical fiber.

In another implementation consistent with the present invention, an optical transmission system includes a first communication path including a first optical fiber configured to receive a test signal and at least one optical isolator disposed along the first communication path. The at least one optical isolator is configured to permit propagation of light in a first direction and substantially prevent propagation of light in a second direction opposite to the first direction. The optical transmission system also includes a second communication path including a second optical fiber and a coupling device coupled to the first optical fiber at a location upstream of the at least one optical isolator. The coupling device is configured to optically couple the first and second optical fibers and allow light from the test signal to be propagated from the first optical fiber to the second optical fiber. The light propagated onto the second optical fiber propagates in the first direction, reaches a termination point and reflects back on the second optical fiber in the second direction.

In a further implementation consistent with the present invention, a method for locating faults in an optical communication system is provided. The optical communication system includes first and second optical fibers that form an optical fiber pair having a first end and a second end. The method includes supplying a first test signal to the first end of the first optical fiber using an optical time domain reflectometer, where the first test signal propagates in a first direction. The method also includes directing light from the first test signal onto the second optical fiber via a coupling device. The directed light propagates in the first direction on the second optical fiber and reflects back in a second direction on the second optical fiber. The method further includes receiving, at the optical time domain reflectometer, the reflected light on the second optical fiber and analyzing the reflected light to determine whether any faults exist in the optical communication system.

In still another implementation consistent with the present invention, a repeater is provided. The repeater includes a first optical fiber configured to receive an optical signal and a coupling system configured to couple a portion of said optical signal to a second optical fiber. The repeater also includes an isolator configured to ensure uni-directional propagation of optical signal energy, wherein said coupling system is connected to said first optical fiber at a location upstream of said isolator.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates a conventional approach for detecting faults in an optical communication system;

FIG. 2 illustrates problems associated with using the conventional approach of FIG. 1 in a distributed Raman amplified optical communication system;

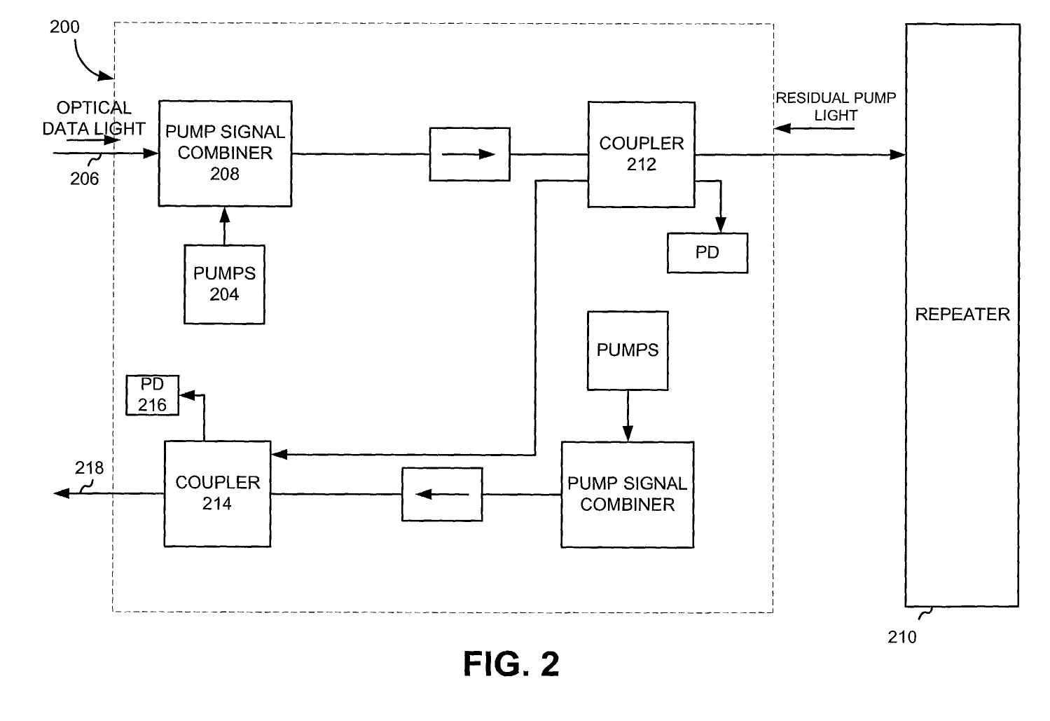

FIG. 3 illustrates an exemplary system in which methods and systems consistent with the present invention may be implemented;

FIG. 4 illustrates an exemplary configuration of a portion of the underwater network of FIG. 3 in an implementation consistent with the present invention; and

FIG. 5 illustrates exemplary signal propagation associated with the portion of the network illustrated in FIG. 4 in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Implementations consistent with the present invention couple a first optical fiber to a second optical fiber upstream of an isolation device located on the first optical fiber. A test signal may then travel to the second optical fiber and reflect back on the second optical fiber where it can then be analyzed.

### Exemplary System Configuration

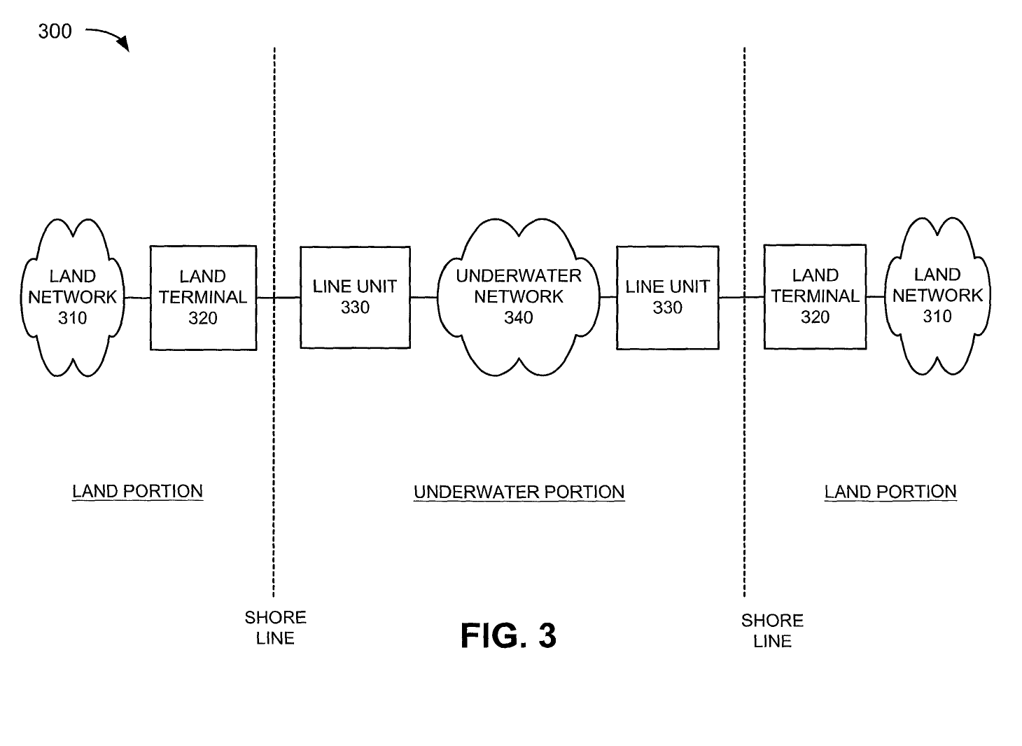

FIG. 3 illustrates an exemplary system 300 in which methods and systems consistent with the present invention may be implemented. System 300 includes two land communication portions that are interconnected via an underwater communication portion. The land portions may include land networks 310 and land terminals 320. The underwater portion may include line units 330 and an underwater network 340. Two land networks 310, land terminals 320, and line units 330 are illustrated for simplicity. It will be appreciated that a typical system may include more or fewer devices and networks than are illustrated in FIG. 3.

The land network 310 may include one or more networks, such as the Internet, an intranet, a wide area network (WAN), a local area network (LAN), or another type of network. Land terminals 320 include devices that convert signals received from the land network 310 into optical signals for transmission to the line unit 330, and vice versa. The land terminals 320 may connect to the land network 310 via wired, wireless, or optical connections. In an implementation consistent with the present invention, the land terminals 320 connect to the line units 330 via optical connections.

The land terminals 320 may include, for example, long reach transmitters/receivers that convert signals into an optical format for long haul transmission and convert underwater optical signals back into a format for transmission to the land network 310. The land terminals 320 may also include wave division multiplexers and optical conditioning units that multiplex and amplify optical signals prior to transmitting these signals to line units 330, and line current equipment that provides power to the line units 330 and underwater network 340.

The underwater network 340 may include groups of line units and/or other devices capable of routing and amplifying optical signals in an underwater environment. The line units 330 include devices capable of receiving optical signals and transmitting these signals to other line units 330 via the underwater network 340. Line units 330 may also be referred to as “repeaters.”

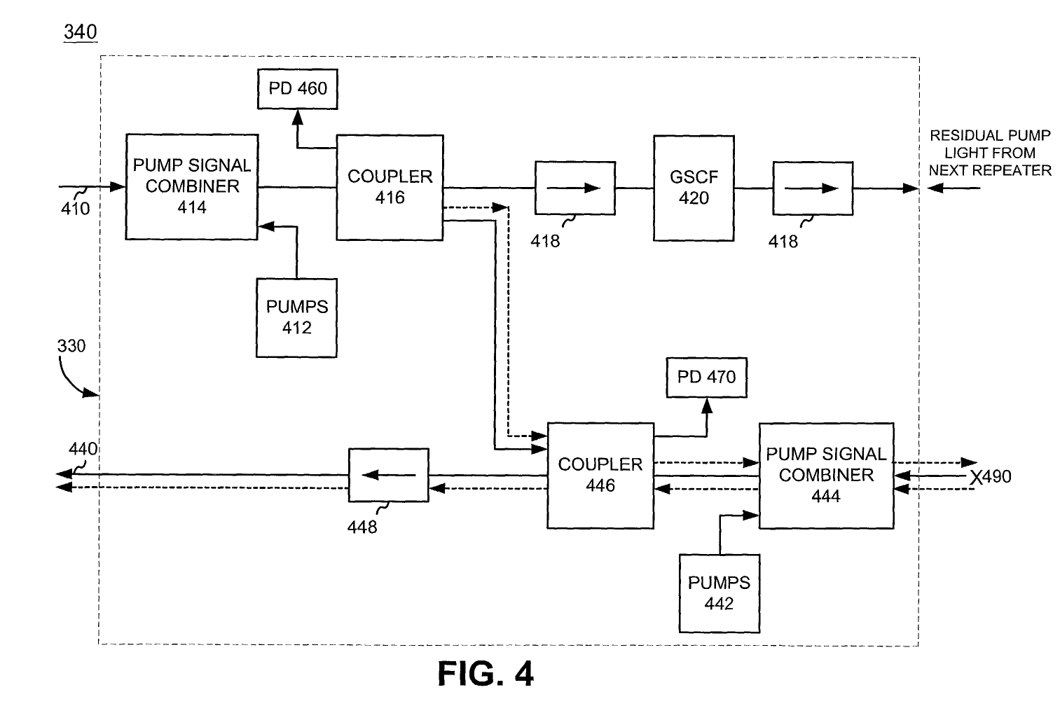

FIG. 4 illustrates an exemplary configuration of a portion of underwater network 340 of FIG. 3, consistent with an implementation of the present invention. Referring to FIG. 4, underwater network 340 may include optical fibers 410 and 440, pumps 412 and 442, pump signal combiners 414 and 444, couplers 416 and 446, two isolators 418, isolator 448, a gain shape compensation filter (GSCF) 420 and photodetectors 460 and 470.

In an exemplary implementation consistent with the present invention, the pumps 412 and 442, pump signal combiners 414 and 444, couplers 416 and 446, isolator 448 and photodetectors 460 and 470 may be included within one or more line units 330, as indicated by the dashed box in FIG. 4. A single pair of optical fibers 410 and 440 and various devices associated with transmitting optical signals are illustrated in FIG. 4 for simplicity. It should be understood that a typical line unit 330 may connect to many pairs of optical fibers and may include other devices, such as gain shape filters, other isolators and couplers, etc. (not shown), that aid in the reception, processing, or transmission of optical signals.

In an exemplary implementation consistent with the present invention, GSCF 420 and its accompanying isolators 418 are located downstream of other signal path components in a line unit 330 and are deployed to compensate for gain excursion in the signals transmitted on optical fiber 410. In an exemplary implementation, a GSCF 420 may be deployed on an optical signal path, such as optical fiber 410, once for every predetermined number of line units 330. For example, a GSCF 420 may be deployed on optical fiber 410 in every fifth line unit 330. In other implementations, a GSCF 420 may be deployed more or less frequently based on the particular system requirements and characteristics of the optical communication system.

Optical fibers 410 and 440 may include conventional fibers that transmit optical signals and form a fiber pair. In an exemplary implementation of the present invention employing Raman amplification, pumps 412 and 442 may include a number of radiation sources that generate light having various wavelengths and various powers using individual radiation emitters. The radiation emitters may include lasers, light emitting diodes, fiber lasers, fiber coupled microchip lasers, semiconductor lasers and other light sources. Combiners (not shown) combine the various outputs of the pump radiation sources, e.g., by wave division multiplexing, and send the combined outputs to a coupling device (not shown). The coupling device may take contributions from all the inputs, provide a representative output and send the output to the respective pump signal combiners 414 and 444.

Pump signal combiners 414 and 444 receive the optical signals carried via the optical fibers 410 and 440 and combine the signals with radiation energy from the pumps 412 and 442. In a Raman pump architecture, the radiation energy from pumps 412 and 442 may counter-propagate with respect to a signal transmitted on the respective optical fibers 410 and 440 to effectively amplify the signal. Alternatively, pumps 412 and 442 may be forward pumping sources used in place of or in addition to the contrapropagating pumps described above. In any event, pump signal combiners 414 and 444 couple light generated by the pump sources 412 and 442 to the optical fibers 410 and 440 to pump or amplify the optical data signals.

Couplers 416 and 446 optically couple signals from optical fiber 410 to optical fiber 420, and vice versa, as described in more detail below. By locating the coupler 416 upstream of the isolators 418 (i.e., before the isolators as seen with respect to the normal transmission direction of signals on the optical fiber 410), the underwater network 340 is able to utilize optical fiber 440 as part of both the sending path of a test signal and a return path for the reflected signal. Moreover, this location for coupler 416 isolates photodetector 460 from residual contrapropagating pump light transmitted by the next repeater (not shown) in system 300.

GSCF 420 may include a conventional filter used to compensate for gain excursion on optical fiber 410. A similar GSCF 420 may be connected to optical fiber 440. As discussed previously, GSCF 420 may be placed once for every predetermined number of line units 330. Optical isolators 418 may be conventional isolators used in connection with the GSCF 420 to limit the optical transmissions to a single direction, as indicated by the arrows in FIG. 4. As shown in FIG. 4, two isolators 418, one on either side of the GSCF 420, may be used in conjunction with GSCF 420 to prevent the backward propagation of light on optical fiber 410 from reaching coupler 416.

Optical isolator 448 may include a conventional isolator used in connection with an amplifier or a GSCF to limit the optical transmission on optical fiber 440 to a single direction. The photodetectors 460 and 470 may include conventional detectors that convert optical signals into electrical signals and are used for monitoring optical signals transmitted on optical fibers 410 and 440. These photodetectors 460 and 470 may be used in conjunction with an OTDR to determine whether a fault has occurred on one of the optical fibers 410 and 440.

The exemplary configuration of the underwater network 440 in FIG. 4 enables the present invention to use an OTDR to detect faults in either of optical fibers 410 and 440, as described in more detail below. More specifically, strategically locating the couplers 416 and 446 upstream of isolators in their respective optical signal paths ensures that test signals can be propagated back to the source (i.e., the OTDR). In addition, the configuration illustrated in FIG. 4 also avoids backward pump power from distorting optical measurements, as described in more detail below.

### Exemplary Signal Propagation

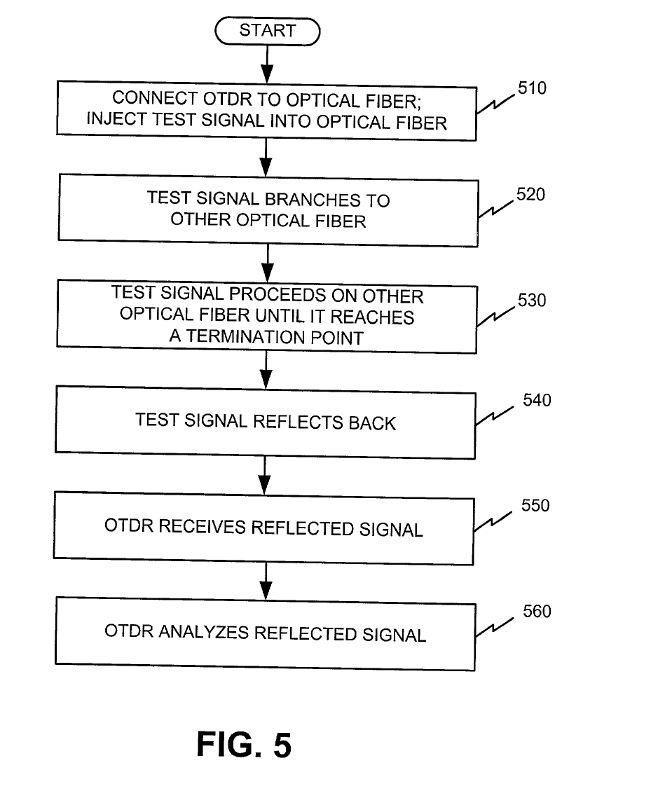

FIG. 5 illustrates exemplary signal propagation associated with detecting discontinuities, such as faults or breaks in the optical fibers 410 and 440, in the portion of network 340 illustrated in FIG. 4. Testing begins by connecting an OTDR to optical fiber 410 (act 510). The OTDR, consistent with the present invention, may be a coherent optical time domain reflectometer (COTDR). The OTDR, as described previously, operates by analyzing reflected light to determine the presence and location of discontinuities or faults in an optical transmission system. One or more photodetectors, such as photodetectors 460 and 470, that monitor the optical signals at various points in the underwater network 340 may also be used to detect the location of faults in the underwater network 340.

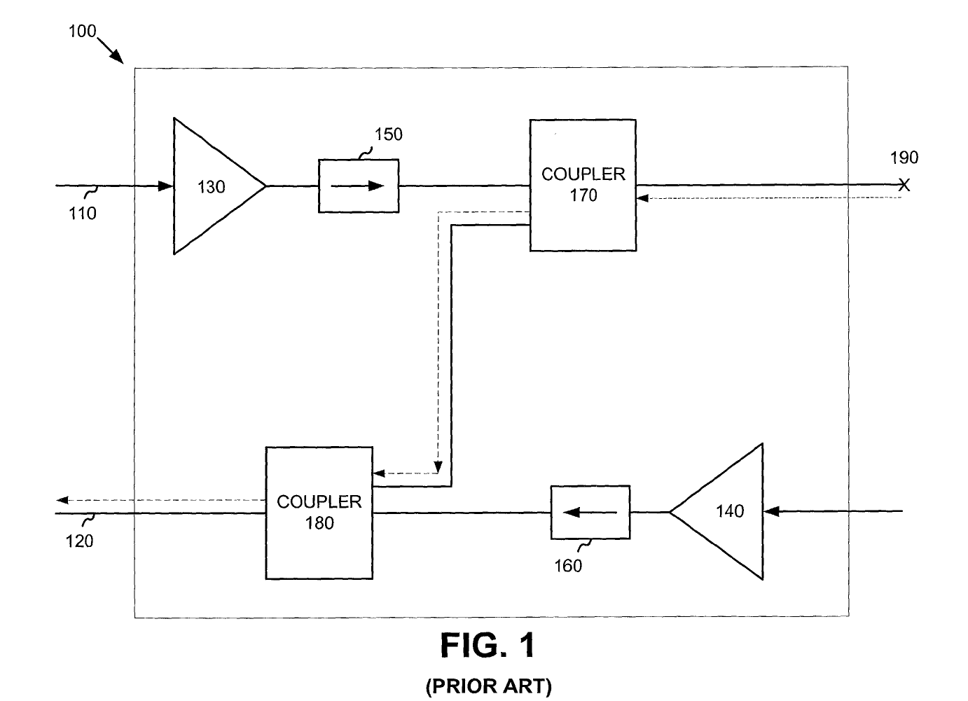

The OTDR may inject a test signal into optical fiber 410 (act 510). The test signal passes through the pump signal combiner 414, where it may be combined with radiation energy from pumps 412, and continues on to coupler 416. At coupler 416, the majority of the test signal proceeds on optical fiber 410 through isolators 418 and GSCF 420. In the configuration illustrated in FIG. 4, however, the isolators 418 prevent reflections from this portion of the test signal from being transmitted back to its source on optical fiber 410. According to conventional techniques, such as those described in relation to FIG. 1, this would prevent the OTDR from being able to analyze the reflected light for fault detection. The present invention, however, uses couplers 416 and 418 to ensure that the OTDR is able to analyze the reflected light.

When the test signal reaches coupler 416, a portion of the test signal branches from coupler 416 to coupler 446, as indicated by the dashed lines in FIG. 4 (act 520). Couplers 416 and 446 may be 1% or 2% couplers. In this case, the light from the test signal passes from coupler 416 to coupler 446, where it is optically coupled onto optical fiber 440. It should be understood that the test signal branches to optical fiber 440 at the same time it is propagating through coupler 416 on optical fiber 410. The power of the signal branching to optical fiber 440, however, may be lower than the power of the signal propagating on optical fiber 410.

The test signal on optical fiber 440 then proceeds through pump signal combiner 444 until it reaches a termination point, labeled point 490 in FIG. 4, as indicated by the dashed lines (act 530). The termination point 490 may represent the interface between the underwater portion and land portion of network 300 at land terminal 320. Alternatively, the termination point 490 may represent a break in optical fiber 440.

The optical test signal reflects back from termination point 490 on optical fiber 440, as indicated by the dashed lines (act 540). More specifically, the optical test signal passes back through the pump signal combiner 444 and on to coupler 446. The signal passes through coupler 446 and isolator 448. As illustrated in FIG. 4, the isolator 448 is aligned in the direction in which the reflected test signal is propagating on optical fiber 440, thereby enabling the reflected signal to reflect back to the origination point. That is, the test signal reflects back to the OTDR, since optical fibers 410 and 440 originate at the same location. The OTDR may then receive the reflected test signal on optical fiber 440 (act 550).

The OTDR may then analyze various characteristics of the reflected signal to determine if any faults have occurred along the optical fiber pair 410 and 440 (act 560). For example, the OTDR may analyze the magnitude of the reflected signal and determine if any faults have occurred, based on the magnitude and the particular network configuration.

In a similar manner, an OTDR may inject a test signal into optical fiber 440 at an opposite end of the communication path to determine if faults exist. For example, the OTDR may inject the test signal on optical fiber 440 at, for example, point 490 (FIG. 4). At some appropriate point, a coupling device similar to that illustrated in FIG. 4 directs the test signal to optical fiber 410. The test signal may then propagate on optical fiber 410 until it reaches a termination point. The test signal then reflects back on optical fiber 410 to the OTDR. In this manner, both optical fibers 410 and 440 and the devices coupled to the respective optical fibers may be checked for continuity and faults.

### CONCLUSION

Systems and methods, consistent with the present invention, provide a configuration for testing for faults in an optical communication system. An advantage of the present invention is that any isolators located downstream of the strategically located coupling device have no effect on the return path for a test signal. That is, since the return path for the reflected signal exists on another fiber, additional isolators will not block the return path for the test signal. In addition, the use of such isolators may advantageously prevent power from contrapropagating pumps from leaking into photodetectors that monitor signal power levels. Another advantage in certain implementations of the present invention is that the reflected signal may have an increased amplitude, as compared to conventional systems, due to contrapropagating pumps that may be in close proximity to the point where the signal is reflected.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the above description focused on an underwater environment, implementations consistent with the present invention are not so limited. For example, the configuration of the optical communication system described above could alternatively be implemented in other environments, such as ground-based, space, or aerospace environments.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. In an optical communication system comprising at least two optical fibers, a method of locating faults, the method comprising:
supplying an optical test signal to a first optical fiber, wherein the optical test signal propagates on the first optical fiber in a first direction;
providing a coupling device to optically couple the first optical fiber to a second optical fiber;
receiving the optical test signal on the second optical fiber via the coupling device, wherein the optical test signal propagates on the second optical fiber in the first direction, reaches a termination point on the second optical fiber and reflects back on the second optical fiber in a second direction opposite to the first direction; and
analyzing the reflected signal received on the second optical fiber.

2. The method of claim 1, further comprising:
determining whether any faults exist on at least one of the first and second optical fibers based on the analyzing.

3. The method of claim 1, wherein the analyzing includes analyzing the reflected test signal using an optical time domain reflectometer.

4. The method of claim 1, wherein the receiving the optical test signal on the second optical fiber includes:
receiving a portion of light associated with the optical test signal via the coupling device.

5. The method of claim 1, wherein the optical test signal reaches a termination point on the first optical fiber, reflects back on the first optical fiber in the second direction and is blocked from propagating to its origination point by at least one isolator disposed on the first optical fiber, and
wherein the at least one isolator is associated with a filtering device coupled to the first optical fiber.

6. The method of claim 5, further comprising:
transmitting the optical test signal through a plurality of repeater devices located upstream of the filtering device.

7. The method of claim 6, wherein the filtering device comprises a gain shape compensation filter.

8. The method of claim 5, further comprising:
connecting the coupling device to the first optical fiber at a location upstream of the filtering device and at least one isolator.

9. An optical transmission system, comprising:
a first communication path comprising a first optical fiber configured to receive a test signal;
at least one optical isolator disposed along the first communication path, the at least one optical isolator being configured to permit propagation of light in a first direction and substantially prevent propagation of light in a second direction opposite to the first direction;
a second communication path comprising a second optical fiber; and
a coupling device coupled to the first optical fiber at a location upstream of the at least one optical isolator, the coupling device being configured to:
optically couple the first and second optical fibers, and
allow light from the test signal to be propagated from the first optical fiber to the second optical fiber, and
wherein the light propagated onto the second optical fiber propagates in the first direction, reaches a termination point and reflects back on the second optical fiber in the second direction.

10. The optical transmission system of claim 9, farther comprising:
an analyzing tool configured to analyze the reflected signal received on the second optical fiber.

11. The optical transmission system of claim 10, wherein the analyzing tool comprises an optical time domain reflectometer.

12. The optical transmission system of claim 9, further comprising:
an optical time domain reflectometer configured to:
transmit the test signal on the first optical fiber, and
analyze the reflected light on the second optical fiber.

13. The optical transmission system of claim 9, further comprising:
a gain shape compensation filter disposed on the first optical fiber and coupled to the at least one optical isolator, wherein the coupling device is coupled to the first optical fiber at a location upstream of the gain shape compensation filter.

14. The optical transmission system of claim 9, further comprising:
a plurality of repeaters disposed on the first communication path at a location upstream of the at least one optical isolator, the repeaters being configured to amplify the test signal.

15. The optical transmission system of claim 14, further comprising:
a filtering device coupled to the at least one optical isolator, the filtering device being located externally from the plurality of repeaters.

16. The optical transmission system of claim 9, further comprising:
a photodetector disposed on the first communication path; and
a pump source optically coupled to the first optical fiber at a location downstream from the photodetector, the pump source being configured to propagate energy to the first optical fiber in the second direction, whereby the energy is prevented from propagating to the photodetector by the at least one isolator.

17. An optical communication system, comprising:
a first optical fiber configured to receive a test signal and propagate the test signal in a first direction;
a plurality of repeaters coupled to the first optical fiber, each repeater being configured to amplify the test signal;
an optical isolator coupled to one of the repeaters, the optical isolator preventing propagation of a reflection of the test signal in a second direction opposite to the first direction;
a second optical fiber; and
a coupler configured to optically couple the first optical fiber to the second optical fiber, and
wherein the test signal propagates on the second optical fiber in the first direction, reaches a termination point and reflects back in the second direction on the second optical fiber.

18. The optical communication system of claim 17, further comprising:
an optical time domain reflectometer, the optical time domain reflectometer being configured to:
generate the test signal,
inject the test signal into the first optical fiber, and
analyze the reflected signal received on the second optical fiber.

19. The optical communication system of claim 17, further comprising:
a filtering device coupled to the at least one isolator, wherein the filtering device and the at least one isolator are located externally from the plurality of repeaters.

20. A method for locating faults in an optical communication system, the optical communication system including first and second optical fibers forming an optical fiber pair having a first end and a second end, the method comprising:
supplying, using an optical time domain reflectometer, a first test signal to the first end of the first optical fiber, the first test signal propagating in a first direction;
directing light from the first test signal onto the second optical fiber via a coupling device, the directed light propagating in the first direction on the second optical fiber and reflecting back in a second direction on the second optical fiber;
receiving, at the optical time domain reflectometer, the reflected light on the second optical fiber; and
analyzing the reflected light to determine whether any faults exist in the optical communication system.

21. The method of claim 20, further comprising:
transmitting the first test signal through a plurality of repeaters, each repeater configured to amplify the first test signal using Raman amplification techniques.

22. The method of claim 21, wherein the at least one isolator comprises first and second isolators, the first and second isolators being coupled to a gain shape compensation filter disposed on the first optical fiber.

23. The method of claim 22, wherein the gain shape compensation filter and the first and second isolators are located externally from the plurality of repeaters.

24. The method of claim 20, further comprising:
supplying, using an optical time domain reflectometer, a second test signal to the second end of the second optical fiber, the second test signal propagating in the second direction;
directing light from the second optical test signal onto the first optical fiber, the directed light propagating in the second direction on the first optical fiber and reflecting back in the first direction on the first optical fiber;
receiving, at the optical time domain reflectometer, the reflected light on the first optical fiber; and
analyzing the reflected light to determine whether any faults exist in the optical communication system.

25. A system for locating faults in an optical communication system, comprising:
means for transmitting a test signal in a first direction on a first optical fiber;
means for optically coupling the first optical fiber to a second optical fiber, wherein the test signal propagates on the second optical fiber in the first direction and reflects back in a second direction opposite to the first direction; and
means for analyzing the reflected test signal.

26. An optical communication system, comprising:
a first optical fiber configured to transmit optical signals in a first direction;
a second optical fiber configured to transmit optical signals in a second direction opposite to the first direction;
an optical isolator disposed on the first optical fiber, the optical isolator being configured to limit the propagation of optical signals to a first direction;
a filter disposed on the first optical fiber and coupled to the optical isolator, the filter being configured to filter the optical signals; and
a coupler configured to receive an optical test signal from the first optical fiber and optically couple the optical test signal to the second optical fiber, the coupler being connected to the first optical fiber at a location upstream of the optical isolator, and
wherein the optical test signal propagates on the second optical fiber in the first direction and reflects back on the second optical fiber in the second direction.

27. The optical communication system of claim 26, further comprising:
an optical time domain reflectometer, the optical time domain reflectometer being configured to:
generate the optical test signal,
inject the optical test signal onto the first optical fiber, and
analyze the reflected signal received on the second optical.

28. The optical communication system of claim 26, further comprising:
a plurality of repeaters coupled to the first optical fiber, each of the repeaters configured to amplify optical signals transmitted on the first optical fiber, and
wherein at least one of the plurality of repeaters employ Raman amplification techniques to amplify the optical signals.

29. A repeater comprising:
a first optical fiber configured to receive an optical signal;
a coupling system configured to couple a portion of said optical signal to a second optical fiber; and
an isolator configured to ensure unidirectional propagation of optical signal energy,
wherein said coupling system is connected to said first optical fiber at a location upstream of said isolator.

30. The repeater of claim 29, further comprising:
a detector connected to said second optical fiber and configured to detect a power level associated with said optical signal, wherein said location of said connection of said coupling system to said first optical fiber upstream of said isolator isolates said detector from contrapropagating pump energy.

31. A repeater comprising:
a first optical fiber configured to receive an optical signal;
at least one optical isolator disposed on the first optical fiber, the at least one optical isolator being configured to permit propagation of light in a first direction and substantially prevent propagation of light in a second direction opposite to the first direction;
a second optical fiber; and
a coupling system coupled to the first optical fiber at a location upstream of the at least one optical isolator, the coupling system being configured to:
optically couple the first and second optical fibers, and
allow light from the optical signal to be propagated from the first optical fiber to the second optical fiber, and
wherein the light propagated onto the second optical fiber propagates in the first direction, reaches a termination point and reflects back on the second optical fiber in the second direction.

32. The repeater of claim 31, further comprising:
a gain shape compensation filter disposed on the first optical fiber and coupled to the at least one optical isolator, wherein the coupling system is coupled to the first optical fiber at a location upstream of the gain shape compensation filter.
